(19) United States
(12) Patent Application Publication
(10) Pub. No.: US 2019/0333004 A1
(43) Pub. Date: Oct. 31, 2019

(54) PROCESSING SYSTEM, PROCESSING METHOD, AND NON-TRANSITORY STORAGE MEDIUM

(71) Applicant: NEC Corporation, Tokyo (JP)

(72) Inventors: Jun UCHIMURA, Tokyo (JP); Hiroshi TAKAHASHI, Kanagawa (JP); Masato WATANABE, Kanagawa (JP)

(73) Assignee: NEC Corporation, Tokyo (JP)

(21) Appl. No.: 16/394,461

(22) Filed: Apr. 25, 2019

(30) Foreign Application Priority Data
Apr. 27, 2018 (JP) 2018-087057

(51) Int. Cl. G06Q 10/08; G01S 17/89; H04N 1/32

(52) U.S. Cl. CPC G06Q 10/087; H04N 1/32117; G01S 17/89

(57) ABSTRACT

The invention provides a processing system including an information acquisition unit that acquires product attribute information from a product having a loading table surface side to which the product attribute information is attached, a judging unit that judges whether or not a sales time limit determined on the basis of the product attribute information has passed, and an output unit that outputs information indicating a judging result of the judging unit.

This application is based on Japanese patent application No. 2018-087057, the content of which is incorporated hereinto by reference.

### BACKGROUND

### Technical Field

The present invention relates to a processing system, a processing method, and a program.

### Related Art

In order to avoid selling of a product past its use-by date or best-before date, work of checking the use-by date or the best-before date of a product in display and collecting a product close to the date or a product past the date is periodically or on an irregular base performed in a store.

Japanese Patent Application Publication No. 2014-238703 discloses a technology for printing a code indicating the expiration date of a purchased product on a receipt.

Japanese Patent Application Publication No. 2004-125452 discloses a topography measurement method using a three-dimensional laser scanner.

PCT Japanese Translation Patent Application Publication No. 2015-531095 discloses a technology for detecting an obstacle using Light Detection and Ranging (LIDAR).

### SUMMARY

The number of products handled in the store is enormous. Thus, a large amount of time and effort is spent checking the use-by dates or the best-before dates of all products. Thus, a product such as a bento box or rice ball that generally has a relatively short use-by date or best-before date is preferentially set as a target to be checked. In this case, the checking work is not sufficiently performed for products having a relatively long use-by date or best-before date, and the possibility of overlooking expiration is increased. Any of Japanese Patent Application Publication No. 2014-238703, Japanese Patent Application Publication No. 2004-125452, and PCT Japanese Translation Patent Application Publication No. 2015-531095 does not have a disclosure related to the problem and does not provide a solution.

An object of the invention is to enable provision of information for increasing the efficiency of a checking work for a product sold in a store.

In one example embodiment, there is provided a processing system comprising an information acquisition unit that acquires product attribute information from a product having a loading table surface side to which the product attribute information is attached, a judging unit that judges whether or not a sales time limit determined on the basis of the product attribute information has passed, and an output unit that outputs information indicating a judging result of the judging unit.

In another example embodiment, there is provided a processing method executed by a computer, the method comprising acquiring product attribute information from a product having a loading table surface side to which the product attribute information is attached, judging whether or not a sales time limit determined on the basis of the product attribute information has passed, and outputting information indicating a judging result in the step of judging.

In still another example embodiment, there is provided a program causing a computer to function as an information acquisition unit that acquires product attribute information from a product having a loading table surface side to which the product attribute information is attached, a judging unit that judges whether or not a sales time limit determined on the basis of the product attribute information has passed, and an output unit that outputs information indicating a judging result of the judging unit.

According to the invention, information for increasing the efficiency of a checking work for a product sold in a store can be provided.

### BRIEF DESCRIPTION OF THE DRAWINGS

The above and other objects, advantages and features of the present invention will be more apparent from the following description of certain preferred example embodiments taken in conjunction with the accompanying drawings, in which:

FIG. 1 is a diagram illustrating one example of a function block diagram of a processing system 10 of the present example embodiment;

FIG. 2 is a diagram illustrating one example of a hardware configuration of an apparatus of the example embodiment;

FIG. 3 is a flowchart illustrating one example of a flow of process of the processing system 10 of the example embodiment;

FIG. 4 is a diagram illustrating one example of a function block diagram of the processing system 10 of the example embodiment;

FIG. 5 is a diagram illustrating one example of a hardware configuration of the apparatus of the example embodiment;

FIG. 6 is a diagram schematically illustrating one example of a product 101 to which a code C is attached;

FIG. 7 is a diagram illustrating one example of the product 101 loaded on a loading table;

FIG. 8 is a diagram schematically illustrating one example of a light emission apparatus;

FIG. 9 is a diagram schematically illustrating one example of information generated by the processing system 10 of the example embodiment;

FIG. 10 is a diagram schematically illustrating one example of information output by the processing system 10 of the example embodiment;

FIG. 11 is a flowchart illustrating one example of a flow of process of the processing system 10 of the example embodiment;

FIG. 12 is a flowchart illustrating one example of a flow of process of the processing system 10 of the example embodiment; and

FIG. 13 is a diagram schematically illustrating one example of information processed by the processing system 10 of the example embodiment.

### DETAILED DESCRIPTION

The invention will be now described herein with reference to illustrative example embodiments. Those skilled in the art will recognize that many alternative example embodiments can be accomplished using the teachings of the present invention and that the invention is not limited to the example embodiments illustrated for explanatory purposes.

### First Example Embodiment

First, a summary of a processing system of the present example embodiment will be described. In the present example embodiment, product attribute information for determining the sales time limit of each product is attached to each product. For example, a seal on which the product attribute information is printed may be stuck on the product, or the product attribute information may be printed on a package or the like of the product. The processing system acquires the product attribute information from each of one or a plurality of products loaded on the loading table and determines the sales time limit of each product on the basis of the acquired product attribute information. The processing system judges whether or not each product is past its determined sales time limit and outputs a judging result.

According to the processing system of the present example embodiment, the efficiency of a work of checking the use-by date or the best-before date of each product sold in the store and collecting a product close to the date or past the date can be increased. Consequently, the efficiency of the checking work for products sold in the store can be increased.

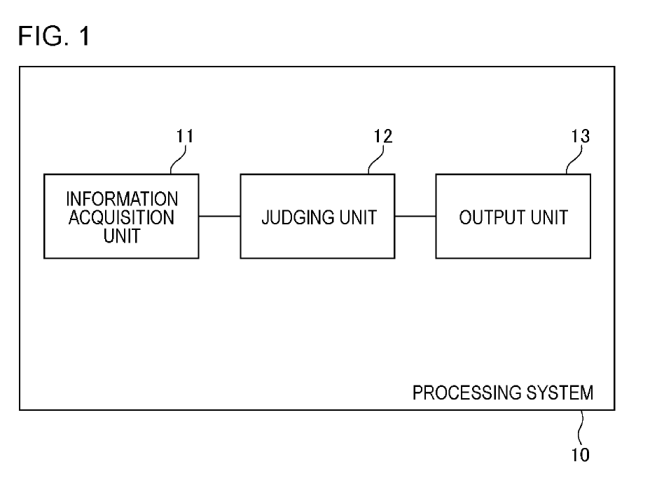

Hereinafter, a configuration of the processing system of the present example embodiment will be described in detail. FIG. 1 illustrates one example of a function block diagram of a processing system 10. As illustrated, the processing system 10 includes an information acquisition unit 11, a judging unit 12, and an output unit 13. The processing system 10 may be implemented by a plurality of physically and/or logically separated apparatuses or may be implemented by physically and/or logically one apparatus.

Each function unit included in the processing system 10 is implemented by any combination of hardware and software mainly based on a central processing unit (CPU) of any computer, a memory, a program loaded into the memory, a storage unit (can store not only the program stored in advance in the stage of shipment of the apparatus but also the program downloaded from a storage medium such as a compact disc (CD) or a server or the like on the Internet) such as a hard disk storing the program, and a network connection interface. Those skilled in the art will understand that various modification examples are available for the implementation method and the apparatus.

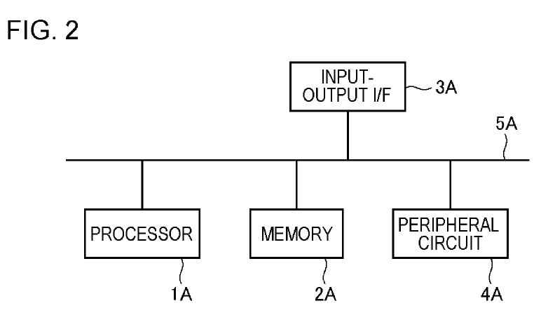

FIG. 2 is a block diagram illustrating a hardware configuration of the processing system 10. As illustrated in FIG. 2, the processing system 10 includes a processor 1A, a memory 2A, an input-output interface 3A, a peripheral circuit 4A, and a bus 5A. The peripheral circuit 4A includes various modules. The peripheral circuit 4A may not be included. Note that in a case where the processing system 10 is implemented by a plurality of physically and/or logically separated apparatuses, each apparatus can have the hardware configuration.

The bus 5A is a data transfer path for the processor 1A, the memory 2A, the peripheral circuit 4A, and the input-output interface 3A to transmit and receive data with each other. The processor 1A is an operation processing apparatus such as a CPU or a graphics processing unit (GPU). The memory 2A is a memory such as a random access memory (RAM) or a read only memory (ROM). The input-output interface 3A includes, for example, an interface for acquiring information from an input apparatus, an external apparatus, an external server, an external sensor, and the like, an interface for outputting information to an output apparatus, the external apparatus, the external server, and the like. The input apparatus is, for example, a keyboard, a mouse, or a microphone. The output apparatus is, for example, a display, a speaker, a printer, or a mailer. The processor 1A can send an instruction to each module and perform an operation on the basis of the operation result of the module.

A functional configuration of each function unit will be described with reference to FIG. 1 again. The information acquisition unit 11 acquires the product attribute information from a product having a loading table surface side to which the product attribute information is attached. The “product attribute information” is information that enables determination of the sales time limit of each product. The product attribute information may be attached to the product in a state where the product attribute information is coded as, for example, a one-dimensional code or a two-dimensional code. Besides, the product attribute information that is not coded and is represented by text may be attached. The product attribute information is attached on the outer surface of the product. For example, a seal on which the product attribute information is printed may be stuck on the outer surface of the product, or the product attribute information may be printed on a package or the like of the product. The “sales time limit” is a time limit until which each product can be sold.

The “loading table surface” is a surface of the loading table on which the product is loaded. The “product having a loading table surface side to which the product attribute information is attached” is a product of which the product attribute information faces the loading table surface. The product to which the product attribute information is attached is loaded on the loading table such that the product attribute information faces the loading table surface. The product loaded on the loading table in accordance with the rule is the product having a loading table surface side to which the product attribute information is attached.

For example, the information acquisition unit 11 can acquire the product attribute information attached to each of one or a plurality of products loaded on the loading table by analyzing an image generated by capturing the product from the loading table surface side. In a case where a plurality of products are included in the image, the information acquisition unit 11 can acquire the product attribute information attached to each of the plurality of products.

The judging unit 12 judges whether or not the sales time limit determined on the basis of the product attribute information acquired by the information acquisition unit 11 has passed. The judging unit 12 judges whether or not the sales time limit has passed by comparing the determined sales time limit with the current date and time. In a case where the product attribute information attached to each of the plurality of products is acquired by the information acquisition unit 11, the judging unit 12 can judge whether or not each of the plurality of products is past its sales time limit.

The output unit 13 outputs information indicating the judging result of the judging unit 12. That is, the output unit 13 outputs information indicating whether or not the product is past its sales time limit. In a case where the judging unit 12 judges whether or not each of the plurality of products is past its sales time limit, the output unit 13 can output information indicating whether or not each of the plurality of products is past its sales time limit. The output unit 13 can output the information through any output apparatus such as a display, a projection apparatus, a speaker, or a mailer.

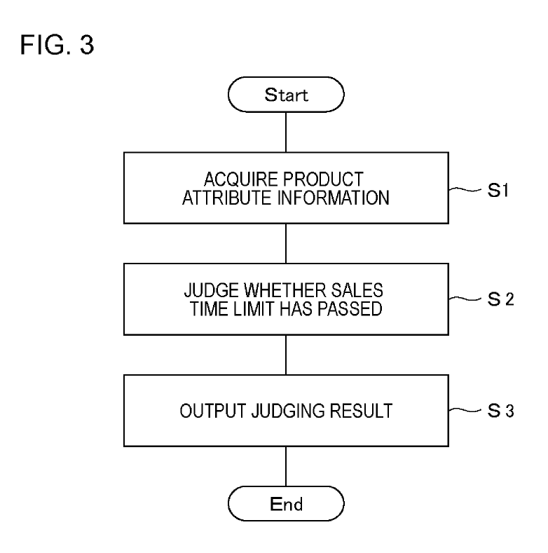

Next, one example of a flow of process of the processing system 10 of the present example embodiment will be described using a flowchart in FIG. 3.

In S1, the information acquisition unit 11 acquires the product attribute information from the product 101 having a loading table surface side to which the product attribute information is attached. In a case where a plurality of products 101 are loaded on the loading table, the information acquisition unit 11 can acquire the product attribute information from each of the plurality of products 101.

In S2, the judging unit 12 judges whether or not the product 101 is past its sales time limit determined on the basis of the product attribute information acquired in S1. In a case where the information acquisition unit 11 acquires the product attribute information related to each of the plurality of products 101 in S1, the judging unit 12 can judge whether or not each of the plurality of products 101 is past its sales time limit.

In S3, the output unit 13 outputs information indicating the judging result of the judging unit 12 in S2. In a case where the judging unit 12 judges whether or not each of the plurality of products is past its sales time limit in S2, the output unit 13 can output information indicating whether or not each of the plurality of products is past its sales time limit.

The processing system 10 of the present example embodiment can acquire the product attribute information for determining the sales time limit of each of one or a plurality of products loaded on the loading table from each product, judge whether or not each product is past its sales time limit on the basis of the acquired product attribute information, and output the judging result. According to the processing system 10 of the present example embodiment, the efficiency of the work of checking the use-by date or the best-before date of each product sold in the store and collecting a product close to the date or a product past the date can be increased. Consequently, the efficiency of the checking work for products sold in the store can be increased.

### Second Example Embodiment

The processing system 10 of the present example embodiment performs the same process as the processing system 10 of the first example embodiment, but the content of the process is more detailed. Hereinafter, a description will be provided.

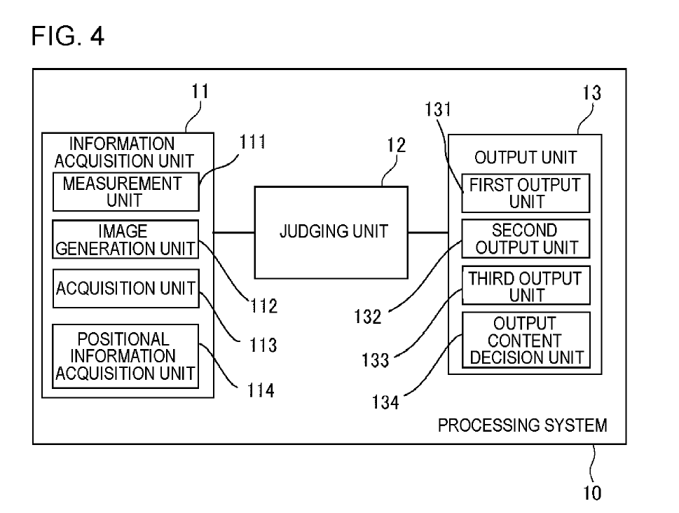

FIG. 4 illustrates one example of a function block diagram of the processing system 10. As illustrated, the processing system 10 includes the information acquisition unit 11, the judging unit 12, and the output unit 13. The information acquisition unit 11 includes a measurement unit 111, an image generation unit 112, an acquisition unit 113, and a positional information acquisition unit 114. In addition, the output unit 13 includes a first output unit 131, a second output unit 132, a third output unit 133, and an output content decision unit 134. Note that the output unit 13 may not include at least one of the first output unit 131, the second output unit 132, and the third output unit 133. The processing system 10 may be implemented by a plurality of physically and/or logically separated apparatuses or may be implemented by physically and/or logically one apparatus.

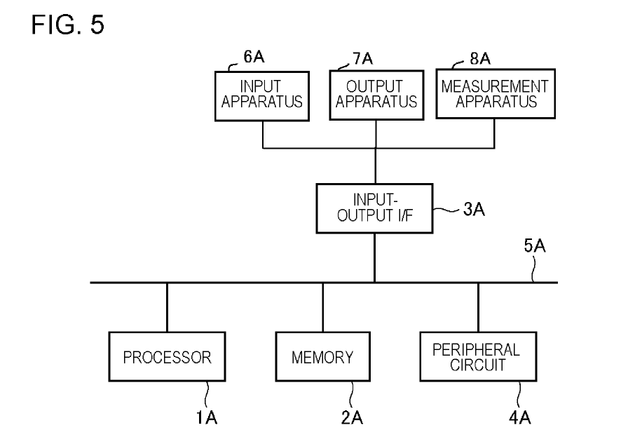

FIG. 5 is a block diagram illustrating a hardware configuration of the processing system 10. As illustrated in FIG. 5, the processing system 10 includes the processor 1A, the memory 2A, the input-output interface 3A, the peripheral circuit 4A, the bus 5A, an input apparatus 6A, an output apparatus 7A, and a measurement apparatus 8A. The peripheral circuit 4A includes various modules. The peripheral circuit 4A may not be included. Note that in a case where the processing system 10 is implemented by a plurality of physically and/or logically separated apparatuses, each apparatus can have the hardware configuration.

The processor 1A, the memory 2A, the input-output interface 3A, the peripheral circuit 4A, the bus 5A, the input apparatus 6A, and the output apparatus 7A are the same as described in the first example embodiment.

The measurement apparatus 8A radiates light, receives reflected light, and measures a period of time from light emission until light reception, light reception strength, or the like. The measurement apparatus 8A is illustrated by LIDAR that radiates laser light and receives reflected light. Data that is input from the measurement apparatus 8A is stored in the memory 2A. The processor 1A can generate an image using the data input from the measurement apparatus 8A and analyze the image by executing a predetermined program. The generated image is a strength image indicating the light reception strength, a distance image indicating a distance to an object, or the like. In addition, the processor 1A can control the output apparatus connected through the input-output I/F 3A and output an operation result.

A functional configuration of each function unit will be described with reference to FIG. 4 again. The information acquisition unit 11 acquires product information indicated by a code from the product having a loading table surface side to which the code is attached. The acquisition of the product information is implemented by the measurement unit 111, the image generation unit 112, the acquisition unit 113, and the positional information acquisition unit 114 illustrated in FIG. 4.

In the present example embodiment, the code that indicates the product information including the product attribute information is attached to each product. The code of the present example embodiment is a two-dimensional code but may be a one-dimensional code or the like.

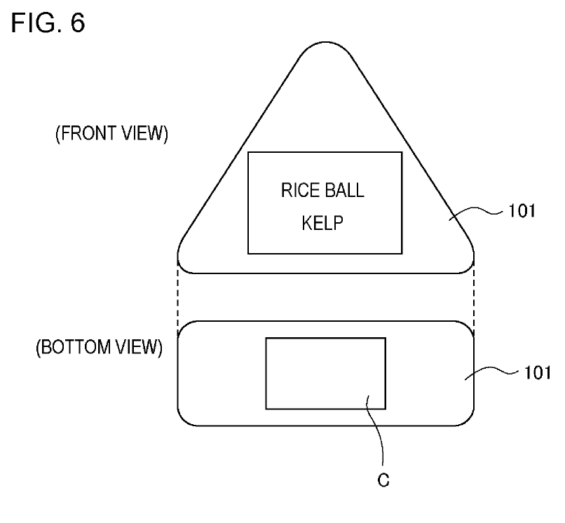

FIG. 6 illustrates one example of the product 101 to which a code C is attached. In the illustrated example, a seal on which the code C is printed is stuck on the product 101. The illustrated product 101 is a rice ball, and the code C is attached on the bottom surface of the product 101. Note that the position at which the code C is attached is not limited to the bottom surface and may be other parts.

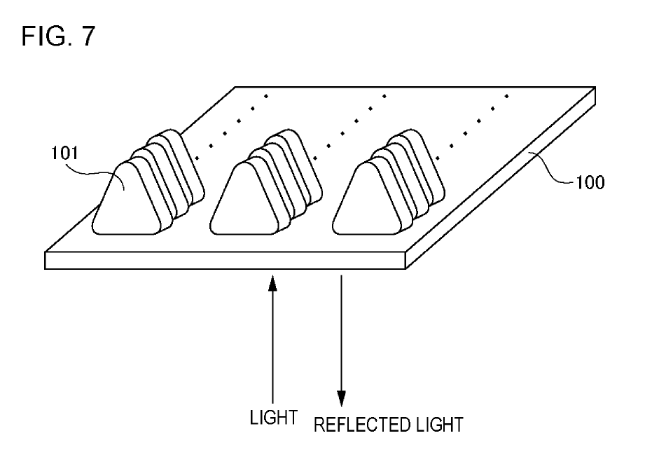

The loading table of the present example embodiment is a display shelf for the product 101. The product 101 is displayed on a shelf plate 100 of the display shelf as illustrated in FIG. 7. The product 101 is displayed such that the code C faces a loading surface of the shelf plate 100. The product loaded on the loading table in accordance with the rule is the product having a loading table surface side to which the code C is attached. The part of the product 101 where the code C is attached may be in contact with or separated from the loading table surface.

The measurement unit 111 radiates light, for example, laser light, toward the product 101 loaded on the loading table surface, receives reflected light, and measures the period of time from light emission until light reception, the light reception strength, or the like. The measurement unit 111 is, for example, LIDAR.

The measurement unit 111 measures the period of time from light emission until light reception, the light reception strength, or the like by radiating light from the side of the surface on the side opposite to the loading table surface and receiving reflected light as illustrated in FIG. 7. The shelf plate 100 is configured to transmit light radiated from at least one surface side. Specifically, the shelf plate 100 is configured to transmit light radiated from the side of the surface on the side opposite to the loading table surface. Thus, light radiated from the side of the surface on the side opposite to the loading table surface is transmitted through the shelf plate 100 and reaches the product 101 loaded on the loading table surface as illustrated in FIG. 7. Note that the shelf plate 100 may be configured to transmit or reflect light radiated from the loading table surface side.

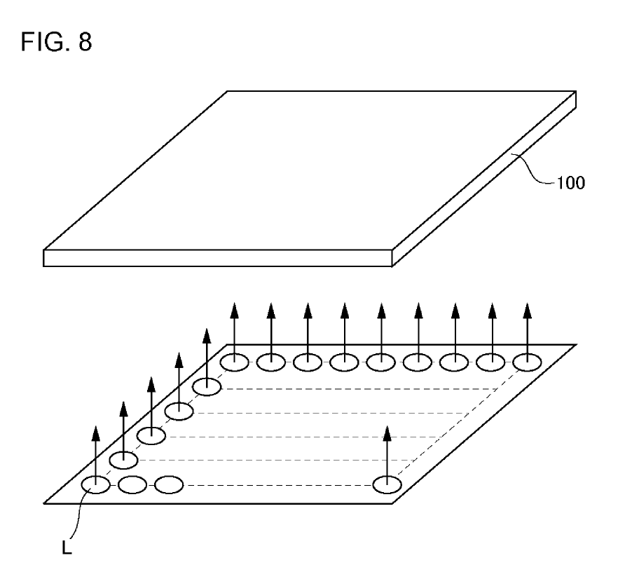

For example, as illustrated in FIG. 8, a light emission apparatus in which light sources L are two-dimensionally arranged may be arranged parallel to the shelf plate 100, and light may be radiated toward the shelf plate 100 from the light emission apparatus. By doing so, data of a desired measurement range can be collected without changing the radiation direction of light. In a case where data of a predetermined range is collected by changing the radiation direction of light, as the distance from the light source L is increased, the interval of a measured point group is increased, and the accuracy of measurement data is decreased. In the case of the configuration illustrated in FIG. 8, the interval of the measured point group depends on the interval of the light sources L and does not depend on the distance from the light source L. Consequently, by sufficiently decreasing the interval of the light sources L, high accuracy measurement data can be collected. Note that a configuration in which measurement is performed by changing the radiation direction of light can also be employed even though the accuracy of measurement data is decreased.

The image generation unit 112 generates an image on the basis of the measurement data generated by the measurement unit 111. The measurement data indicates the period of time from light emission until light reception, the light reception strength, or the like. The image generation unit 112 generates the strength image indicating the light reception strength, the distance image indicating the distance to the object, or the like on the basis of the measurement data. For example, the strength image may be an image in which the value of the light reception strength is normalized to values of a plurality of stages and is illustrated using a grayscale.

As described above, the shelf plate 100 is configured to transmit light radiated from the side of the surface on the side opposite to the loading table surface. The product 101 is loaded such that the code C faces the loading table surface. Thus, the generated image includes the surface of each product 101 on which the code C is attached. The pattern of the code C is shown in the strength image.

The acquisition unit 113 acquires the product information related to each product 101 by analyzing the generated image. The acquisition unit 113 performs a process of detecting the product 101 in the image, a process of detecting the code C in the image, and a process of analyzing the pattern of the code C and acquiring the product information.

First, the acquisition unit 113 performs a process of detecting the product 101 in the image. The image analyzed in the process may be the strength image or may be the distance image. For example, the acquisition unit 113 detects one or a plurality of products 101 included in the image by performing a contour extraction process on the image, a process of extracting a contour satisfying a shape condition or a size condition from extracted contours, and the like.

The shape condition or the size condition can be set for each display area. The product 101 displayed in each display area is determined in advance. Therefore, for each display area, the shape or the size of the product displayed in each display area can be set as a condition. By setting the shape or size condition, a predetermined product 101 in the image can be detected with high accuracy.

After the product 101 in the image is detected, the acquisition unit 113 performs a process of detecting the code C in the image and a process of analyzing the pattern of the code C and acquiring the product information. The image analyzed in the process is the strength image. For example, using pattern matching technology or the like, the acquisition unit 113 detects the code C from an area in which the product 101 is present in the image. Then, the acquisition unit 113 acquires the product information indicated by the code C with respect to each product 101 by analyzing the pattern of the detected code C and converting the pattern into information.

The positional information acquisition unit 114 acquires positional information that indicates the position of each product 101 detected by the acquisition unit 113. The positional information indicates the position of each product 101 as coordinates in a two-dimensional coordinate system in which an x axis and a y axis are set in any direction with any point in the image as an origin. For example, the coordinates of a representative point in the area in which each product 101 is present in the image can be set as the positional information related to each product 101.

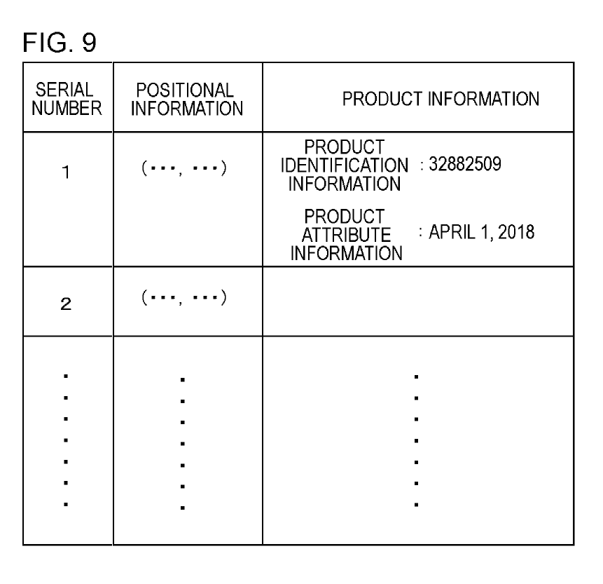

The process performed by the information acquisition unit 11 generates an image analysis result illustrated in FIG. 9. In the image analysis result, the positional information related to each of one or a plurality of products 101 detected in the process of detecting the product 101 is associated with the product information acquired from each product 101. Note that for the product 101 for which the product information cannot be acquired for various reasons such as inability to detect the code C or inability to convert the pattern of the code C into information even though the product 101 is detected as the product 101 in the image, only the positional information is registered, and the product information is not registered.

The judging unit 12 determines the sales time limit of each product 101 on the basis of the product attribute information included in the product information acquired by the information acquisition unit 11. The judging unit 12 judges whether or not each product 101 is past its sales time limit by comparing the current date and time with the sales time limit of each product 101.

The product attribute information of the present example embodiment is information for determining the best-before date or the use-by date of each product and is, for example, the best-before date, the use-by date, a lot number, or the sales time limit. The product information may include product identification information for identifying each product 101 in addition to the product attribute information. The product identification information may be information enabling identification of the product 101 and is illustrated by a product number, a product name, or the like.

The sales time limit may be the use-by date or the best-before date or may be a time earlier by a predetermined time period T than the use-by date or the best-before date. In a case where the product attribute information indicates the best-before date or the use-by date of each product 101, the judging unit 12 can determine the best-before date or the use-by date of each product 101 on the basis of the product attribute information. On the other hand, in a case where the product attribute information indicates the lot number or a serial number of each product 101, the judging unit 12 can acquire information indicating the best-before date or the use-by date corresponding to the acquired lot number or serial number from a management server that manages the best-before date or the use-by date of each product 101 for each lot number or serial number.

In a case where the sales time limit is a time earlier by the predetermined time period T than the use-by date or the best-before date, the judging unit 12 can determine the sales time limit of each product 101 on the basis of the predetermined time period T registered in advance and the use-by date or the best-before date of each product 101. Note that the predetermined time period T may be registered for each product 101. For example, it is possible that the “sales time limit of a product A is a time earlier by three hours than the use-by date or the best-before date of the product A”, and the “sales time limit of a product B is a time earlier by five hours than the use-by date or the best-before date of the product B”. In this case, registration information in which the predetermined time period T is registered in advance for each product 101 is generated and is registered in the processing system 10. The judging unit 12 can acquire the predetermined time period T of each product 101 from the registration information and determine the sales time limit of each product 101 on the basis of the information.

The output unit 13 outputs information indicating the judging result of the judging unit 12. The output unit 13 executes at least one of first to third output methods described below. The first output method is implemented by the first output unit 131. The second output method is implemented by the second output unit 132. The third output method is implemented by the third output unit 133. The output content decision unit 134 decides a content to be output on the basis of the judging result of the judging unit 12. The first output unit 131, the second output unit 132, and the third output unit 133 output information that indicates the content decided by the output content decision unit 134.

In the first output method, the first output unit 131 displays information indicating the judging result on the shelf plate 100 using a projection apparatus. In this case, the shelf plate 100 has semi-transmissivity such that light radiated from the loading table surface side is reflected, and light radiated from the side of the surface on the side opposite to the loading table surface is transmitted. The configuration can be implemented using a technology such as a display that transmits backlight and reflects extraneous light. The projection apparatus radiates light from the loading table surface side.

The first output unit 131 can display information that enables identification of the product 101 that is past its sales time limit. In addition, the first output unit 131 can display information that enables identification of the product 101 that is not past its sales time limit. In addition, the first output unit 131 can display information that enables identification of the product 101 for which it is not possible to judge whether or not its sales time limit has passed. In addition, the first output unit 131 can display information that enables identification of the product 101 for which the product information cannot be acquired for various reasons such as inability to detect the code C or inability to convert the pattern of the code C into information even though the product 101 is detected as a product in the image.

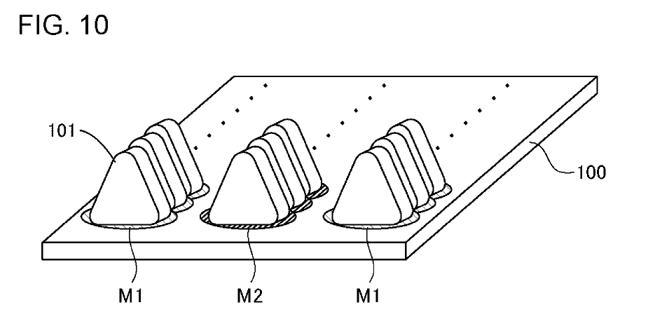

FIG. 10 illustrates one example. In the case of the example illustrated in FIG. 10, the first output unit 131 radiates light to the shelf plate 100 and displays a mark M2 at a loading position of the product 101 past its sales time limit. In addition, the first output unit 131 radiates light to the shelf plate 100 and displays a mark M1 at the loading position of the product 101 not past its sales time limit. While illustration is not provided, the first output unit 131 may display a mark M3 at the loading position of the product 101 for which it is not possible to judge whether or not its sales time limit has passed for various reasons such as inability to detect the product, inability to detect the code C, or inability to convert the pattern of the code C into information. Note that the first output unit 131 may not display any mark at the loading position of the product 101 for which it is not possible to judge whether or not its sales time limit has passed. The mark M1, the mark M2, and the mark M3 are in different display states of color, shape, shading, or the like.

Displayed information can be other information such as a text, a number, and a sign. In addition, while information is displayed to include the loading position of the product 101 in the illustrated example, information may be displayed near the loading position.

The output content decision unit 134 decides a mark to be displayed at the loading position of each product 101 on the basis of the positional information that indicates the loading position of each product 101 acquired by the positional information acquisition unit 114, and the judging result that is generated by the judging unit 12 and indicates whether or not each product 101 is past its sales time limit. For example, the output content decision unit 134 may decide to display the mark M1 at the loading position of the product 101 that is judged to be not past its sales time limit, display the mark M2 at the loading position of the product 101 that is judged to be past its sales time limit, and display the mark M3 at the loading position of the product 101 for which it is not possible to judge whether or not its sales time limit has passed.

In addition, the output content decision unit 134 can convert the loading position of each product 101 illustrated in the coordinate system of the image into coordinates in a coordinate system of a projection area of the projection apparatus on the basis of a conversion rule that is generated in advance for converting the “coordinates in the coordinate system of the image” into the “coordinates in the coordinate system of the projection area of the projection apparatus”. The coordinate system of the projection area of the projection apparatus is a coordinate system in which an x axis direction and a y axis direction are set in any direction with any position in the projection area as an origin.

According to the first output method, a staff member can intuitively judge whether or not each product 101 displayed on the shelf plate 100 is past its sales time limit, whether or not a judgement as to whether or not the sales time limit has passed has been made by the processing system 10, or the like on the basis of the display content on the shelf plate 100, that is, display/non-display of the mark and the content of the mark at the loading position of each product 101. Consequently, the staff member can avoid a tiresome work of visually recognizing the best-before date or the use-by date printed on each product 101 and checking whether or not the sales time limit has passed for each of the plurality of products 101.

In the second output method, the second output unit 132 transmits alert information including the product identification information related to the product 101 past its sales time limit to another predetermined apparatus. The output content decision unit 134 decides the alert information including the product identification information related to the product 101 that is judged to be past its sales time limit by the judging unit 12.

The other apparatus is an apparatus operated by the staff member and is illustrated by a point of sales (POS) register, a tablet terminal, a smartphone, a mobile phone, or the like. Note that the second output unit 132 may further include information indicating a display position of the product 101 past the sales time limit in the alert information. In the case of including the information indicating the display position, the judging unit 12 can include the information indicating the display position of the product 101 past the sales time limit in the judging result to be output. In the present example embodiment, the measurement apparatus 8A is installed for each display area, and each measurement apparatus 8A acquires measurement data for each display area. The judging unit 12 can identify the judging result is based on the measurement data acquired by which measurement apparatus 8A, and can include information indicating the display area corresponding to the identified measurement apparatus 8A in the judging result. Besides, display information that indicates the display area of each product 101 may be generated in advance. The judging unit 12 may determine the display position of the product 101 past the sales time limit by referring to the display information.

According to the second output method, the staff member can recognize the presence, the product identification information, the display position, and the like of the product 101 past its sales time limit on the basis of information displayed on or information output as audio to the POS register, the tablet terminal, the smartphone, the mobile phone, or the like.

In the third output method, the third output unit 133 outputs the alert information including the product identification information, the display position, and the like of the product 101 past its sales time limit through the output apparatus such the display, the speaker, or the printer included in the processing system 10. The output content decision unit 134 decides the alert information including the product identification information related to the product 101 that is judged to be past its sales time limit by the judging unit 12.

The processing system 10 may be implemented by a plurality of physically and/or logically separated apparatuses. The plurality of apparatuses are, for example, a first apparatus that is installed in a sales floor of the store, and, for example, a second apparatus that is installed in a back office of the store. In this case, the second apparatus can include the output apparatus such as the display, the speaker, or the printer. The third output unit 133 can output the alert information through the output apparatus included in the second apparatus.

Note that the third output unit 133 may further include information indicating the display position of the product 101 past the sales time limit in the alert information. In this case, the judging unit 12 can include the information indicating the display position of the product 101 past the sales time limit in the judging result to be output. The way of implementation is as described above.

According to the third output method, the staff member can recognize the presence, the product identification information, the display position, and the like of the product 101 past its sales time limit on the basis of information output from the display, the speaker, the printer, or the like included in the processing system 10.

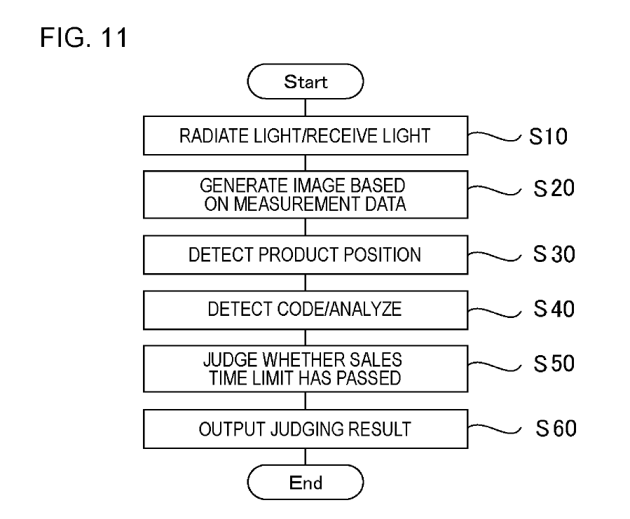

Next, one example of a flow of process of the processing system 10 of the present example embodiment will be described using a flowchart in FIG. 11.

For example, the process of the illustrated flowchart is started in response to a user input that starts the process. An example of a method for the user input will be described. For example, an input apparatus may be installed in the display shelf. The input apparatus is illustrated by a physical button, a touch panel display, a microphone, or the like. The user input may be performed by operating the input apparatus. Note that the input apparatus may be installed for each display area.

The minimum unit of the display area may be a unit of 100 shelf plates, a unit of a small area acquired by dividing the shelf plate 100 into a plurality of parts, a unit of display shelves including a plurality of shelf plates 100, or the like.

Besides, the user input may be performed by operating the POS register, the tablet, the apparatus installed in the back office of the store, or the like. That is, the user input may be remotely performed. In this case, the staff member may specify one or a plurality of display areas in which the process is executed.

Note that the apparatus for performing the user input is configured to be able to communicate with the processing system 10 in a wired and/or wireless manner.

In S10, the measurement unit 111 radiates light, for example, laser light, toward the loading table, receives reflected light, and measures the period of time from light emission until light reception, the light reception strength, or the like. In S20, the image generation unit 112 generates an image on the basis of the measurement data in S10. The image generation unit 112 generates the strength image indicating the light reception strength, the distance image indicating the distance to the object, or the like.

In S30, the acquisition unit 113 analyzes the image generated in S20 and detects the product 101 included in the image. In a case where a plurality of products 101 is present in the image, each of the plurality of products is detected. For example, one or a plurality of products 101 included in the image are detected by performing the contour extraction process on the image, a process of extracting a contour satisfying the shape condition or the size condition from extracted contours, and the like. Then, the positional information acquisition unit 114 acquires the positional information that indicates the loading position of the product 101 detected by the acquisition unit 113. The positional information indicates the position of each product 101 as coordinates in a two-dimensional coordinate system in which an x axis and a y axis are set in any direction with any point in the image as an origin. For example, the coordinates of a representative point in the area in which each product 101 is present in the image can be set as the positional information related to each product 101. As illustrated in FIG. 9, the positional information acquisition unit 114 stores the computed positional information related to each product 101 in a storage apparatus as an image analysis result. Note that the positional information acquisition unit 114 may store information indicating an area in which each product 101 is present in the image in the storage apparatus in association with the positional information related to each product 101.

In S40, the acquisition unit 113 analyzes the image generated in S20 and detects the code C in the image. For example, using pattern matching technology or the like, the acquisition unit 113 detects the code C from an area in which the product 101 is present in the image. Then, the acquisition unit 113 acquires the product information indicated by the code C with respect to each product 101 by analyzing the pattern of the detected code C and converting the pattern into information. In a case where a plurality of codes C are present in the image, the acquisition unit 113 detects the plurality of codes and analyzes and converts each code into the product information. As illustrated in FIG. 9, the acquisition unit 113 can register the product information indicated by the code C detected from an area in which each product 101 is present in the image in association with the positional information registered in S30 with respect to each product 101. Note that for the product 101 for which the product information cannot be acquired for various reasons such as inability to detect the code C or inability to convert the pattern of the code C into information even though the product 101 is detected as the product 101 in the image, only the positional information is registered, and the product information is not registered.

In S50, the judging unit 12 judges whether or not the product 101 is past its sales time limit determined on the basis of the product information acquired in S40.

Specifically, the judging unit 12 determines the sales time limit of each product 101 on the basis of the product information acquired by the acquisition unit 113. The judging unit 12 judges whether or not each product 101 is past its sales time limit by comparing the current date and time with the sales time limit of each product 101.

The sales time limit may be the use-by date or the best-before date or may be a time earlier by the predetermined time period T than the use-by date or the best-before date. In a case where the product attribute information included in the product information indicates the best-before date or the use-by date of each product 101, the judging unit 12 can determine the best-before date or the use-by date of each product 101 on the basis of the product attribute information. On the other hand, in a case where the product attribute information indicates the lot number or the serial number of each product 101, the judging unit 12 can acquire the best-before date or the use-by date corresponding to the acquired lot number or serial number from the management server that manages the best-before date or the use-by date of each product 101 for each lot number or serial number.

In a case where the sales time limit is a time earlier by the predetermined time period T than the use-by date or the best-before date, the judging unit 12 can determine the sales time limit of each product 101 on the basis of the predetermined time period T registered in advance and the use-by date or the best-before date of each product 101. Note that the predetermined time period T may be registered for each product 101. In this case, the registration information in which the predetermined time period T is registered in advance for each product 101 is generated and is registered in the processing system 10. The judging unit 12 can acquire the predetermined time period T of each product 101 from the registration information and determine the sales time limit of each product 101 on the basis of the information.

In S60, the output unit 13 outputs information indicating the judging result of the judging unit 12 in S50. The output unit 13 executes at least one of the first to third output methods described above.

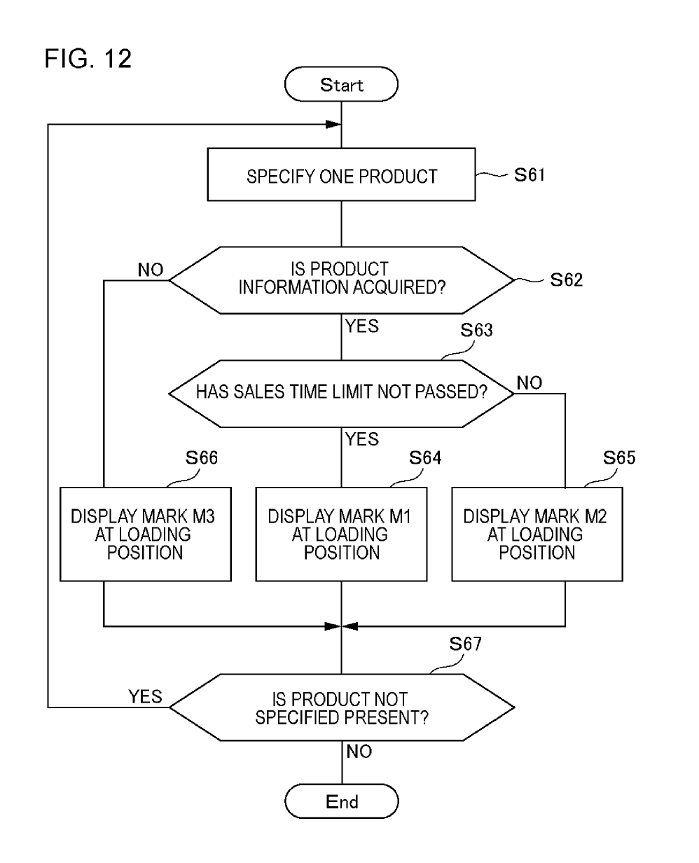

One example of a flow of process in which the output content decision unit 134 decides the content to be output in the first output method will be described using a flowchart in FIG. 12. Note that the process is merely one example and is not for limitation purposes.

The output content decision unit 134 specifies one of products detected in S30 (S61). For example, the output content decision unit 134 specifies one serial number for which the positional information is registered in the image analysis result illustrated in FIG. 9. In a case where the product information related to the specified product is acquired in S40 (Yes in S62), that is, in a case where the product information is registered in association with the specified serial number, the output content decision unit 134 proceeds to S63. In a case where the result of judging in S50 indicates that the “sales time limit has not passed” (Yes in S63), the output content decision unit 134 decides to display the mark M1 at the loading position of the product (S64).

On the other hand, in a case where the result of judging in S50 indicates that the “sales time limit has passed” (No in S63), the output content decision unit 134 decides to display the mark M2 at the loading position of the product (S65).

In addition, in a case where the product information related to the specified product is not acquired (No in S62), that is, in a case where the product information is not registered in association with the specified serial number, the output content decision unit 134 decides to display the mark M3 at the loading position of the product (S66).

The marks M1, M2, and M3 are in different display states of color, shape, shading, or the like and can be identified from each other.

In S67, the output content decision unit 134 checks whether or not a product that is not specified in S61 is present among the products of which the positions are detected in S30. For example, the presence of a serial number not specified in S61 among serial numbers for which the positional information is registered in the image analysis result illustrated in FIG. 9 is checked. In a case where such a serial number is present (Yes in S67), the output content decision unit 134 returns to S61 and repeats the process. In a case where such a serial number is not present (No in S67), the output content decision unit 134 finishes the process.

The processing system 10 of the present example embodiment described above can acquire information for determining the best-before date or the use-by date of each product 101 from each product 101 displayed on the display shelf. The processing system 10 can judge whether or not each product 101 is past its sales time limit on the basis of the acquired information and can output the judging result.

According to the processing system 10 of the present example embodiment, the staff member can avoid a tiresome work of visually recognizing the best-before date or the use-by date printed on each product 101 and checking whether or not the sales time limit has passed for each of the plurality of products 101.

In addition, according to the processing system 10 of the present example embodiment, a judgement as to whether or not the sales time limit has passed can be made in a state where the product 101 is displayed. Thus, the staff member does not need to perform a tiresome work such as moving the product 101 to any location in order to perform the work of checking whether or not the sales time limit has passed.

In addition, since a judgement as to whether or not the sales time limit has passed can be made in a state where the product 101 is displayed, for example, an operation of picking up the product 101 for checking the best-before date or the use-by date printed on the product 101 can be avoided. Since the opportunity to move the product 101 can be reduced, deterioration in the quality of the product 101 can be reduced.

In addition, according to the processing system 10 of the present example embodiment, the product information is acquired by image analysis. Thus, the plurality of products 101 included in the image can be collectively processed. Thus, the efficiency of work is improved.

As described above, according to the processing system 10 of the present example embodiment, the efficiency of the work of checking the use-by date or the best-before date of the product 101 sold in the store and collecting the product 101 close to the date or past the date can be increased.

### Third Example Embodiment

The processing system 10 of the present example embodiment can set in advance a time at which a process of checking whether or not the sales time limit has passed is executed, and can automatically execute the process when the time is reached. In addition, the processing system 10 of the present example embodiment can set the time for each display area. Other configurations are the same as those of the first and second example embodiments.

One example of a hardware configuration of the processing system 10 of the present example embodiment is the same as that of the first and second example embodiments.

One example of a function block diagram of the processing system 10 of the present example embodiment is illustrated in FIG. 1 and FIG. 4 in the same manner as the first and second example embodiments. As illustrated, the processing system 10 includes the information acquisition unit 11, the judging unit 12, and the output unit 13. Configurations of the judging unit 12 and the output unit 13 are the same as those of the first and second example embodiments. Thus, descriptions of those configurations will not be repeated.

In a case where a preset time is reached, the information acquisition unit 11 executes acquisition of the product attribute information. That is, in a case where the preset time is reached, the measurement unit 111 radiates light, for example, laser light, toward the product 101 loaded on the loading table, receives reflected light, and measures the period of time from light emission until light reception, the light reception strength, or the like. In response to the measurement by the measurement unit 111, the image generation unit 112 performs a process of generating an image on the basis of the measurement data generated by the measurement unit 111. In response to the image generation by the image generation unit 112, the acquisition unit 113 performs a process of acquiring the product information including the product attribute information on the basis of the generated image. In addition, in response to the image generation by the image generation unit 112, the positional information acquisition unit 114 performs a process of acquiring the positional information indicating the loading position of the product 101 included in the image. Other configurations of the information acquisition unit 11 are the same as those of the first and second example embodiments.

In response to the acquisition of the product attribute information performed by the information acquisition unit 11, the judging unit 12 and the output unit 13 execute the process described in the first and second example embodiments.

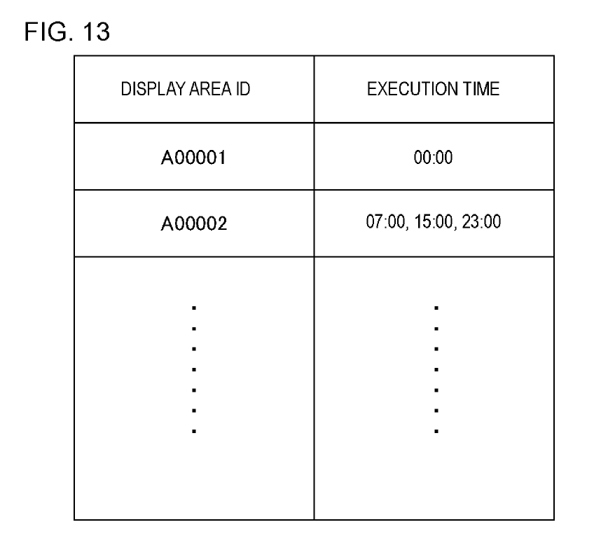

Note that the time at which the information acquisition unit 11 executes the acquisition of the product attribute information may be set for each display area. FIG. 13 illustrates one example. According to the illustrated example, in a display area “A00001”, the acquisition of the product attribute information, the judgement as to whether or not the sales time limit has passed, and the output of the judging result are performed at 00:00 every day. In addition, in a display area “A00002”, the acquisition of the product attribute information, the judgement as to whether or not the sales time limit has passed, and the output of the judging result are performed at 07:00, 15:00, and 23:00 every day.

The minimum unit of the display area may be a unit of 100 shelf plates, a unit of a small area acquired by dividing the shelf plate 100 into a plurality of parts, a unit of display shelves including a plurality of shelf plates 100, or the like.

According to the processing system 10 of the present example embodiment described above, the same advantageous effects as the first and second example embodiments can be implemented.

In addition, according to the processing system 10 of the present example embodiment, in a case where a time at which a process of checking whether or not the sales time limit has passed is executed is set, the process can be automatically executed at a timing at which the time is reached. In the case of a configuration in which the process is executed in response to the user input, the process is not executed in a case where the staff member does not recognize that the time is reached. Consequently, an inconvenience such that the presence of the product 101 past its sales time limit is overlooked, and the product 101 is erroneously sold may occur. According to the processing system 10 of the present example embodiment, the inconvenience can be reduced.

In addition, according to the processing system 10 of the present example embodiment, the time at which the process of checking whether or not the sales time limit has passed is executed can be set for each display area. Thus, the process of checking whether or not the sales time limit has passed can be executed an appropriate number of times and at an appropriate timing for each product 101.

Modification examples of the first to third example embodiments will be described.

In a first modification example, in response to the acquisition of the product attribute information by the information acquisition unit 11, the judging unit 12 judges whether or not a stock quantity of each product 101 matches the number of pieces of product attribute information acquired by the information acquisition unit 11 with respect to each product 101. The output unit 13 outputs the result of judgement performed by the judging unit 12, that is, information that indicates whether or not the stock quantity of each product 101 matches the number of pieces of product attribute information acquired by the information acquisition unit 11 with respect to each product 101.

The stock quantity of each product 101 can be determined on the basis of information registered in a POS system.

One example of a process of computing the number of pieces of product attribute information acquired by the information acquisition unit 11 with respect to each product 101 will be described. The judging unit 12 groups a plurality of pieces of product information that are acquired by the information acquisition unit 11 by collecting the plurality of pieces of product information having the same product identification information. The number of pieces of product information acquired by the information acquisition unit 11 with respect to each product 101 is computed by counting the number of pieces of product information belonging to each group. The product information includes the product attribute information. Thus, the computed number of pieces of product information indicates the number of pieces of product attribute information acquired by the information acquisition unit 11 with respect to each product 101.

Note that the judging unit 12 may judge whether or not the stock quantity of each product 101 matches the number of pieces of product information acquired by the information acquisition unit 11 with respect to each product 101 in response to the acquisition of the product information by the information acquisition unit 11. The output unit 13 may output the result of judgement performed by the judging unit 12, that is, information that indicates whether or not the stock quantity of each product 101 matches the number of pieces of product information acquired by the information acquisition unit 11 with respect to each product 101.

According to the modification example, the staff member can recognize whether or not the current stock quantity of each product 101 managed in the POS system matches the number of products 101 displayed on the display shelf on the basis of the information output from the processing system 10.

In a second modification example, the processing system 10 includes a camera in addition to the measurement apparatus 8A mentioned above. An image including the product 101 displayed on the shelf plate 100 is generated by the camera, and the acquisition of the product attribute information is implemented by analyzing the image. The camera may capture the product 101 from any direction. The product 101 is displayed such that its surface to which the code C is attached faces the camera.

In a third modification example, the loading table on which the product 101 is loaded may not be the shelf plate 100 of the display shelf. The loading table is installed at any position in the store, for example, in the back office. In this case, the staff member temporarily collects the product 101 as a target for checking whether or not the sales time limit has passed from the display shelf, carries the product 101 to the position of the loading table, and loads the product 101 on the loading table. The processing system 10 performs measurement by radiating light and receiving reflected light, capturing using the camera, and the like on the product 101 loaded on the loading table and generates an image.

The modification examples can also implement the same advantageous effect as the present example embodiment.

Hereinafter, reference examples will be appended.

1. A processing system including

an information acquisition unit that acquires product attribute information from a product having a loading table surface side to which the product attribute information is attached,

a judging unit that judges whether or not a sales time limit determined on the basis of the product attribute information has passed, and an output unit that outputs information indicating a judging result of the judging unit.

2. The processing system according to 1,

in which the information acquisition unit includes
a measurement unit that radiates laser light toward the product and receives reflected light of the laser light,
an image generation unit that generates an image on the basis of measurement data generated by the measurement unit, and
an acquisition unit that acquires the product attribute information on the basis of the image.

3. The processing system according to 1 or 2,

in which the information acquisition unit further includes a positional information acquisition unit that acquires information indicating a loading position of the product, and

the output unit includes a first output unit that displays information enabling identification of a loading position of a product past the sales time limit on the loading table.

4. The processing system according to any one of 1 to 3,

in which the output unit includes a second output unit that transmits alert information including at least one of product identification information related to the product past the sales time limit or a display position of the product to another apparatus.

5. The processing system according to any one of 1 to 4,

in which the information acquisition unit executes a process of acquiring the product attribute information when a preset time is reached, and

the judging unit executes a process of judging whether or not the sales time limit has passed in response to the acquisition of the product attribute information performed by the information acquisition unit.

6. The processing system according to 5,

in which the loading table is a display shelf of the product, and

the preset time is set for each display area.

7. The processing system according to any one of 1 to 4,

in which the information acquisition unit executes a process of acquiring the product attribute information in response to a user input, and

the judging unit executes a process of judging whether or not the sales time limit has passed in response to the acquisition of the product attribute information performed by the information acquisition unit.

8. The processing system according to any one of 1 to 7,

in which the judging unit judges whether or not a stock quantity of the product matches the number of pieces of the product attribute information acquired by the information acquisition unit.

9. A processing method executed by a computer, the method comprising:

acquiring product attribute information from a product having a loading table surface side to which the product attribute information is attached,

judging whether or not a sales time limit determined on the basis of the product attribute information has passed, and

outputting information indicating a judging result in the step of judging.

10. A program causing a computer to function as

an information acquisition unit that acquires product attribute information from a product having a loading table surface side to which the product attribute information is attached,

a judging unit that judges whether or not a sales time limit determined on the basis of the product attribute information has passed, and

an output unit that outputs information indicating a judging result of the judging unit.

It is apparent that the present invention is not limited to the above embodiment, and may be modified and changed without departing from the scope and spirit of the invention.

### REFERENCE NUMERALS

1A: processor
2A: memory
3A: input-output I/F
4A: peripheral circuit
5A: bus
6A: input apparatus
7A: output apparatus
8A: measurement apparatus
10: processing system
11: information acquisition unit
12: judging unit
13: output unit
100: shelf plate
101: product
111: measurement unit
112: image generation unit
113: acquisition unit
114: positional information acquisition unit
131: first output unit
132: second output unit
133: third output unit
134: output content decision unit
C: code
L: light source
M1: mark
M2: mark
M3: mark

What is claimed is:

1. A processing system comprising:
at least one memory configured to store one or more instructions; and
at least one processor configured to execute the one or more instructions to:
acquire product attribute information from a product having a loading table surface side to which the product attribute information is attached;
judge whether or not a sales time limit determined on the basis of the product attribute information has passed; and
output information indicating a judging result.

2. The processing system according to claim 1,
wherein the processor is further configured to execute the one or more programs to:
radiate laser light toward the product and receive reflected light of the laser light,
generate an image on the basis of the reflected light, and
acquire the product attribute information on the basis of the image.

3. The processing system according to claim 1,
wherein the processor is further configured to execute the one or more programs to:
acquire information indicating a loading position of the product, and
display information enabling identification of a loading position of a product past the sales time limit on the loading table.

4. The processing system according to claim 1,
wherein the processor is further configured to execute the one or more programs to transmit alert information comprising at least one of product identification information related to the product past the sales time limit or a display position of the product to another apparatus.

5. The processing system according to claim 1,
wherein the processor is further configured to execute the one or more programs to:
execute a process of acquiring the product attribute information when a preset time is reached, and
execute a process of judging whether or not the sales time limit has passed in response to the acquisition of the product attribute information.

6. The processing system according to claim 5,
wherein the loading table is a display shelf of the product, and
the preset time is set for each display area.

7. The processing system according to claim 1,
wherein the processor is further configured to execute the one or more programs to:
execute a process of acquiring the product attribute information in response to a user input, and
execute a process of judging whether or not the sales time limit has passed in response to the acquisition of the product attribute information.

8. The processing system according to claim 1,
wherein the processor is further configured to execute the one or more programs to judge whether or not a stock quantity of the product matches the number of pieces of the product attribute information.

9. A processing method executed by a computer, the method comprising:
acquiring product attribute information from a product having a loading table surface side to which the product attribute information is attached;
judging whether or not a sales time limit determined on the basis of the product attribute information has passed; and
outputting information indicating a judging result.

10. A non-transitory storage medium storing a program causing a computer to:
acquire product attribute information from a product having a loading table surface side to which the product attribute information is attached;
judge whether or not a sales time limit determined on the basis of the product attribute information has passed; and
output information indicating a judging result.
